(19) United States
(12) Patent Application Publication
(10) Pub. No.: US 2009/0292860 A1
(43) Pub. Date: Nov. 26, 2009

(54) METHOD OF PROGRAMMING NON-VOLATILE MEMORY DEVICE

(75) Inventor: Seong Je PARK, Sacheon-si (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hynix Semiconductor Inc., Icheon-si (KR)

(21) Appl. No.: 12/164,015

(22) Filed: Jun. 28, 2008

(30) Foreign Application Priority Data
May 26, 2008 (KR) 2008-48620

(51) Int. Cl. G06F 12/02

(52) U.S. Cl. 711/103; 711/E12.008

(57) ABSTRACT

The present invention relates to a method of programming a non-volatile memory device. A method of programming an non-volatile memory device in accordance with an aspect of the present invention includes inputting n page of data, storing a single page of data in each of page buffer units of a plurality of memory cell units, programming a first page of data stored in a page buffer unit of a first memory cell unit, transferring a second page of data, stored in a page buffer unit of a second memory cell unit, to the page buffer unit of the first memory cell unit, and programming the transferred second page of data into the first memory cell unit.

### CROSS-REFERENCES TO RELATED APPLICATIONS

The present application claims priority to Korean patent application number 10-2008-0048620, filed on May 26, 2008, which is incorporated by reference in its entirety.

### BACKGROUND OF THE INVENTION

The present invention relates to a method of programming a non-volatile memory device.

Recently, there is an increasing demand for non-volatile memory devices which can be electrically programmed and erased and does not need to be periodically refreshed.

A non-volatile memory device is a device that enables electrical program/erase operations, and performs the program and erase operations by changing the threshold voltage of a cell as electrons are moved by a strong electric field applied to a thin oxide layer.

The non-volatile memory device typically includes a memory cell array, in which cells for storing data are arranged in matrix form, and a page buffer for writing memory into specific cells of the memory cell array or reading memory stored in a specific cell. The page buffer includes bit line pairs which are coupled to a specific memory cell and a register for temporarily storing data to be written into the memory cell array or reading data from a specific cell of the memory cell array and temporarily storing the read data. It also includes a sense node for sensing the voltage level of a specific bit line or a specific register, and a bit line select unit for controlling whether the specific bit line and the sense node have been coupled or not.

In accordance with the program operation of this non-volatile memory device, data is input through a data input/output (I/O) unit from outside the non-volatile memory device. The input data is temporarily stored in an input buffer and transferred to each memory cell and programmed therein under the control of a controller. Meanwhile, with the high integration of non-volatile memory devices, the size of a page that needs to be programmed/read at once is increased. Since data that needs to be stored in the input buffer increases, the size of the input buffer should be increased accordingly.

### BRIEF SUMMARY OF THE INVENTION

The present invention relates to a method of programming a non-volatile memory device, which can increase the size of a page in a program operation without adding additional input buffers by storing external input data in page buffers of memory cell units that are not performing a program operation.

In accordance with an aspect of the present invention, there is provided a method of programming a non-volatile memory device, including inputting n pages of data, storing a single page of data in each of page buffer units of a plurality of memory cell units, programming a first page of data stored in a page buffer unit of a first memory cell unit, transferring a second page of data, stored in a page buffer unit of a second memory cell unit, to the page buffer unit of the first memory cell unit, and programming the transferred second page of data into the first memory cell unit.

In accordance with another aspect of the present invention, there is provided a method of programming a non-volatile memory device, including inputting n pages of data, storing a first page of data in a page buffer unit of a first memory cell unit, programming the first page of data into the first memory cell unit, storing a second page of data in a page buffer unit of a second memory cell unit, after a program operation of the first page of data is completed, transferring the second page of data to the page buffer unit of the first memory cell unit, and programming the transferred second page of data to the first memory cell unit.

In accordance with still another aspect of the present invention, there is provided a method of programming a non-volatile memory device, including inputting n pages of data, storing m pages of data in page buffer units of a plurality of memory cell units, respectively, programming a first group of page data stored in a page buffer unit of a first memory cell unit, transferring a second group of page data, stored in a page buffer unit of a second memory cell unit, to the page buffer unit of the first memory cell unit, and programming the second group of transferred page data into the first memory cell unit.

In accordance with further still another aspect of the present invention, there is provided a method of programming a non-volatile memory device, including inputting n pages of data, storing a first group of page data in a page buffer unit of a first memory cell unit, programming the first group of page data into the first memory cell unit, transferring a second group of page data, stored in a page buffer unit of a second memory cell unit, to the page buffer unit of the first memory cell unit, and programming the second group of transferred page data into the first memory cell unit.

In accordance with further still another aspect of the present invention, there is provided a method of programming a non-volatile memory device, including distributing and storing a plurality of pages of data, which will be programmed into a page buffer unit of a first memory cell unit, in respective page buffer units of a plurality of memory cell units, and sequentially programming the stored page of data into the first memory cell unit.

### BRIEF DESCRIPTION OF THE DRAWINGS

FIG. 1 is a block diagram of a non-volatile memory device in accordance with an embodiment of the present invention;

FIG. 2 is a block diagram of a page buffer unit applied to the present invention;

FIG. 3 is a circuit diagram showing a page buffer used in a 3-bit multi-level cell program operation;

FIG. 4 is a flowchart illustrating a method of programming a non-volatile memory device in accordance with an embodiment of the present invention; and

FIG. 5 is a flowchart illustrating a method of programming a non-volatile memory device in accordance with another embodiment of the present invention.

### DESCRIPTION OF SPECIFIC EMBODIMENTS

Specific embodiments according to the present invention will be described with reference to the accompanying drawings. However, the present invention is not limited to the disclosed embodiments, but may be implemented in various ways. The embodiments are provided to complete the disclosure of the present invention and to allow those having ordinary skill in the art to understand the scope of the present invention. The present invention is defined by the category of the claims.

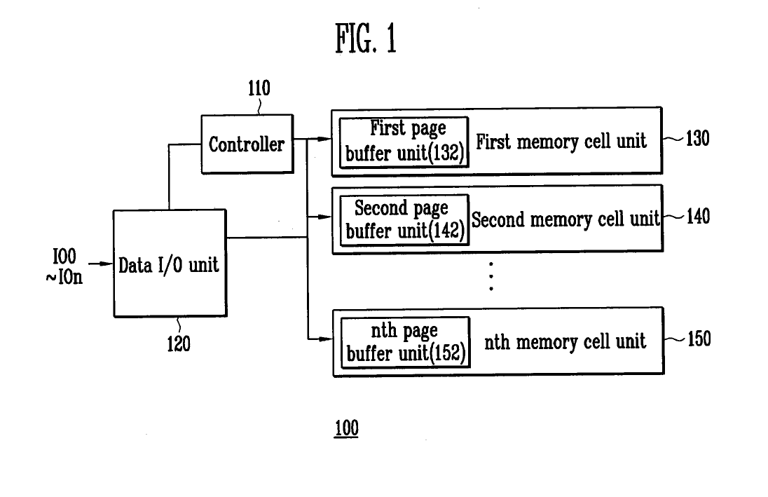

FIG. 1 is a block diagram of a non-volatile memory device in accordance with an embodiment of the present invention. A non-volatile memory device 100 includes a controller 110 for controlling various program/erase/read operations, a data I/O unit 120 for receiving external input data or outputting output data from a memory cell, and a plurality of memory cell units 130, 140, and 150 in which the input data are programmed.

Typically, the non-volatile memory device includes an input buffer for temporarily storing input data received from the data I/O unit 120. In the present embodiment, however, the input buffer is removed, and a page buffer included in each memory cell unit serves as the input buffer.

The controller 110 controls input data received through the data I/O unit 120 to be stored in page buffer units 132, 142, and 152, each included in the respective memory cell units. Each page buffer unit can store data corresponding to one page. Thus, when there are many external input data, input data is temporarily stored in a page buffer of a memory cell unit that does not perform a program operation.

Further, the controller 110 controls data, stored in a page buffer of a second memory cell unit, to be transferred to a page buffer of a first memory cell unit and then programmed into the first memory cell unit. The data I/O unit 120 transfers external input data to a page buffer of each memory cell unit under the control of the controller 110.

The plurality of memory cell units 130, 140, and 150 each includes a page buffer unit that is driven independently during programming (i.e., each can transfer data to any other page buffer unit). A person skilled in the art is familiar with the technique of independently controlling a page buffer unit included in one plane from a page buffer unit included in another plane. Thus, when a plurality of planes is included in a non-volatile memory chip, each plane can become a memory cell unit.

According to another embodiment of the present invention, the memory cell units 130, 140, and 150 may be non-volatile memory chips that are provided as a module. Recently, a non-volatile memory device having a plurality of memory chips has been introduced to store in each chip data received from an external host coupled to the non-volatile memory device. Since each memory chip also includes a page buffer unit that is driven independently, the memory chip can become a memory cell unit. In such a memory device, the input data is temporarily stored in a page buffer of a non-volatile memory chip that is not driven/programmed at that program cycle.

Each of the page buffer units 132, 142, and 152 included in the memory cell units includes a plurality of page buffers, each having one or more registers. A page buffer having two or more registers includes a data transmission unit that is able to transmit data between the registers. Meanwhile, a non-volatile memory device that performs a multi-level cell program requires a different number of registers. For example, a non-volatile memory device that performs a 2-bit multi-level cell program can include a page buffer having three registers. A non-volatile memory device that performs a 3-bit multi-level cell program can include a page buffer having five registers.

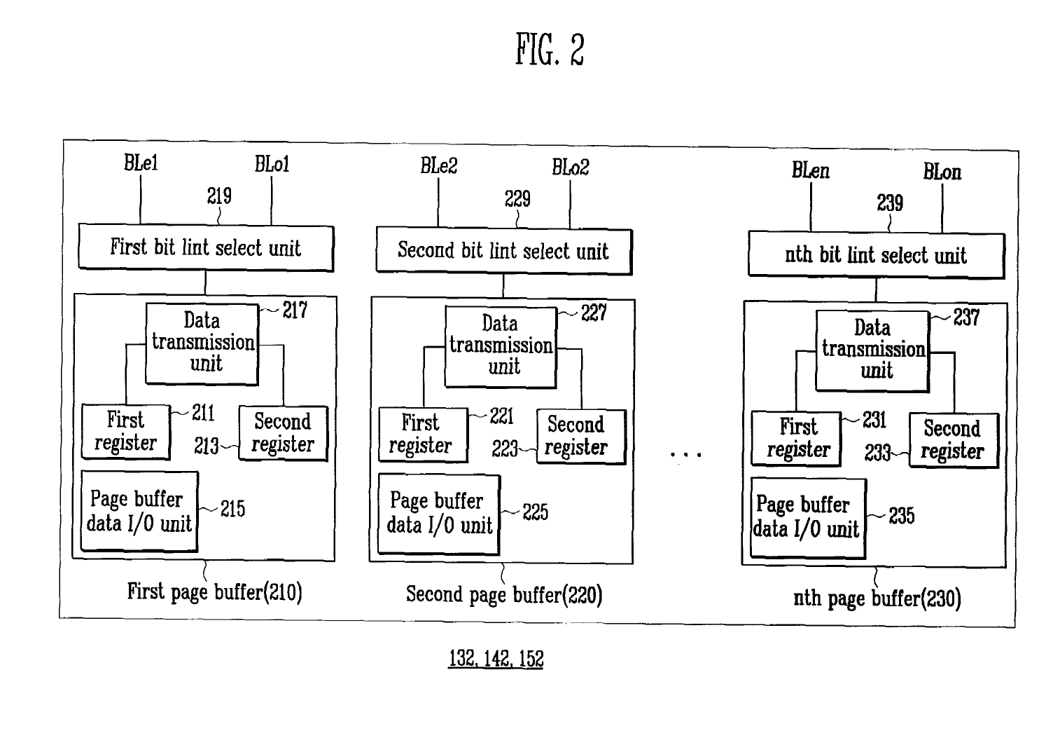

FIG. 2 is a block diagram of the page buffer unit applied to the present invention. Each of the page buffer units 132, 142, and 152 includes a plurality of page buffers. Each page buffer includes two registers, a page buffer data I/O unit, and a data transmission unit. Each page buffer is coupled to a bit line select unit for selectively connecting an even bit line BLe or an odd bit line BLo to a page buffer accordingly to a given control.

According to an embodiment, each page buffer can include one or more registers, e.g., 3 or 5 registers. However, when one page buffer includes a plurality of registers, data transmission units 217, 227, and 237 for transferring data between registers in the page buffer are included as well. Page buffer data I/O units 215, 225, and 235 are generally coupled to any one of a plurality of registers. Data is input to or output from a corresponding register. Thus, in order to store different data in a plurality of registers, external data is input to a first register, and the data stored in the first register is transferred to a second register through a data transmission unit and then stored in the second register. Next, data independent from the data stored in the second register can be applied to the first register through a page buffer data I/O unit.

Through this construction, when each page buffer includes n registers, a single page buffer unit can store n pages. For example, if each page buffer has two registers (or first register 211 and second register 213), the page buffer unit may store two pages of data. Data corresponding to a first page may be stored in first registers, and data corresponding to a second page may be stored in second registers.

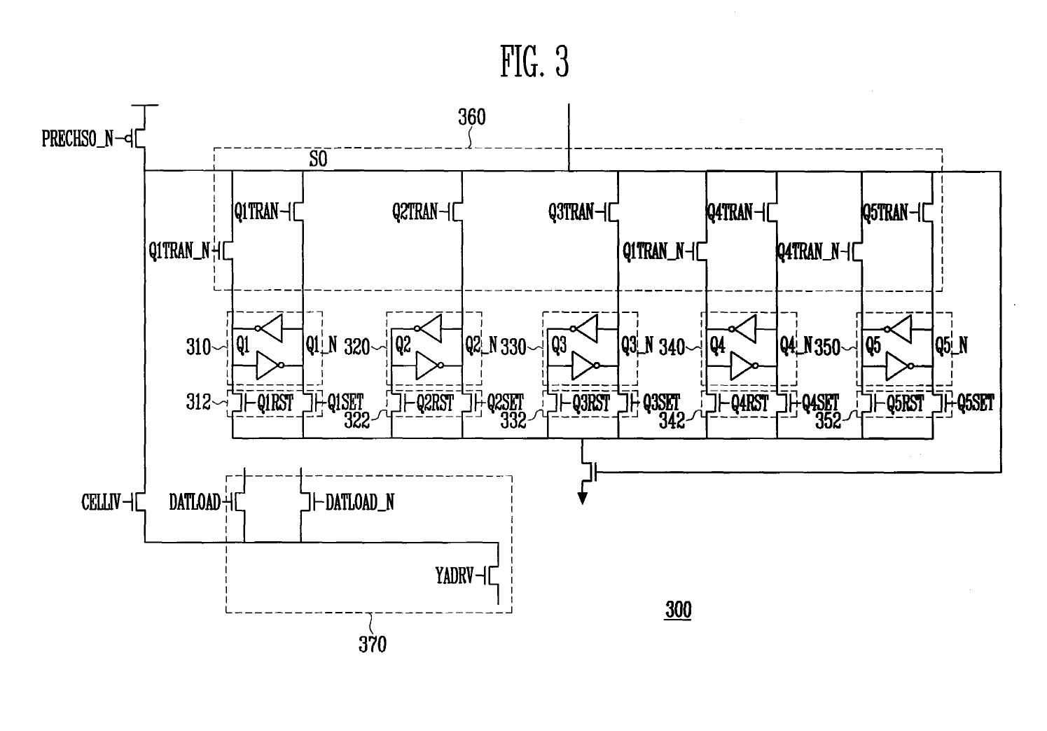

FIG. 3 is a circuit diagram showing a page buffer used in a 3-bit multi-level cell program operation.

A page buffer 300 includes five registers 310, 320, 330, 340, and 350, a data transmission unit 360, and a page buffer data I/O unit 370. This page buffer has a similar construction to that of a general page buffer. The page buffer 300 has five registers in the present embodiment. In the case of a page buffer including five registers as described above, five different data bits can be stored using the page buffer data I/O unit 370 and the data transmission unit 360. Therefore, a page buffer unit including the above page buffer can store five pages.

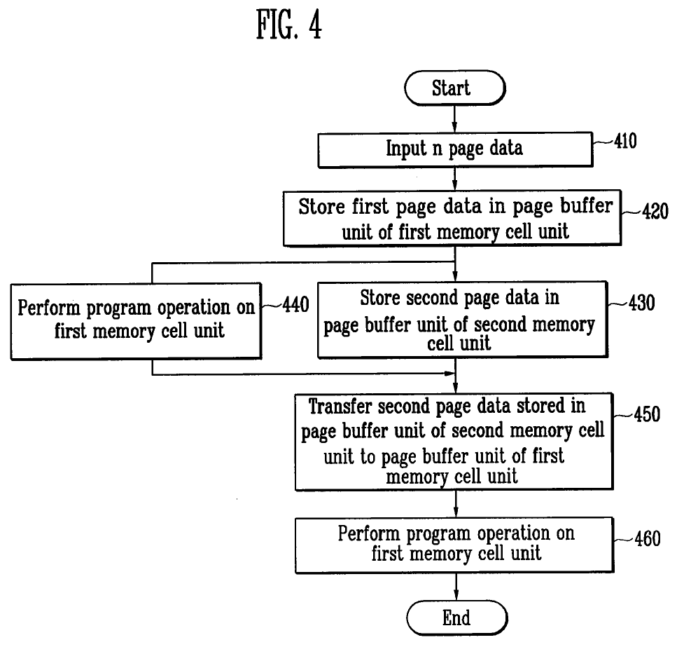

FIG. 4 is a flowchart illustrating a method of programming a non-volatile memory device in accordance with an embodiment of the present invention.

First, external input data is input through the data I/O unit 120 (step 410).

The input data is sequentially stored in the page buffer units associated with a plurality of memory cell units. The input data are stored in the page buffer units without being passed through an input buffer. Each memory cell unit includes a page buffer unit that is independently driven during programming. One memory cell unit is programmed at a time in the present embodiment. When a specific memory cell unit is to be programmed at a given cycle, the remaining memory cell units are not programmed at that time.

At step 430, a first page of data is stored in the page buffer unit of a first memory cell unit that will be programmed. The remaining input data (assuming there is only one more page of data) are stored in a page buffer unit of a memory cell unit that will not be programmed with the first memory cell unit, e.g., the page buffer unit of a second memory cell unit (step 430).

While the input data is being stored in the page buffer unit of the second memory cell unit, the first page of data stored in the page buffer unit of the first memory cell unit is programmed into the memory cells associated thereto (step 440).

In one implementation, the program operation is performed only after all of the input data are stored in the page buffer units of the memory cell units.

After the program operation on the first page of data has been completed, the second page of data stored in the page buffer of the second memory cell unit is transferred to the page buffer unit of the first memory cell unit (step 450). The second page of data is programmed into the first memory cell unit (step 460).

As described above, as data to be stored in a specific memory cell unit is stored in a page buffer of an unused memory cell unit, a program operation can be performed even without an additional input buffer.

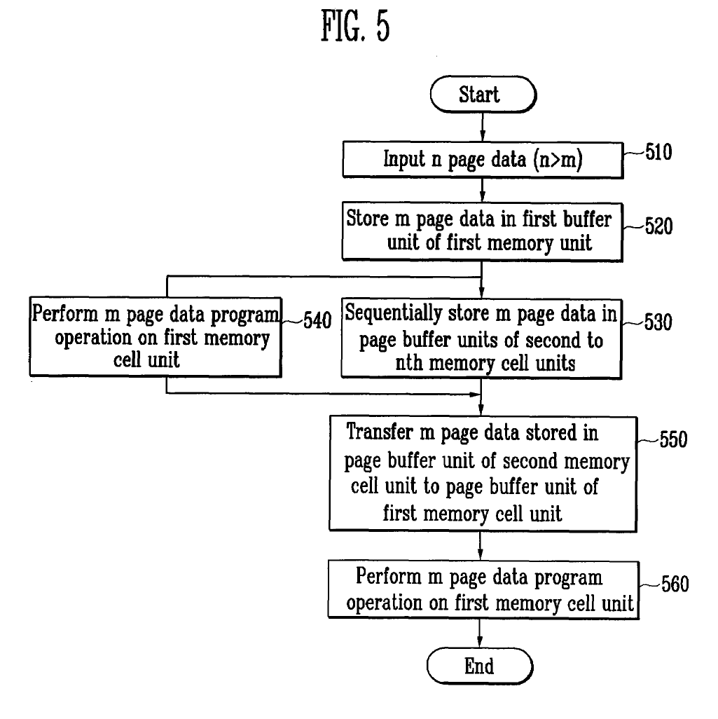

FIG. 5 is a flowchart illustrating a method of programming a non-volatile memory device in accordance with another embodiment of the present invention.

First, n pages of data are input through the data I/O unit 120 (step 510). The n pages of data together comprise the data associated with a program instruction received from an external source, e.g., a user. A page buffer unit of each memory cell unit can include a page buffer having m registers. Each page buffer unit, therefore, can store m pages of data. When n is smaller than m, a program operation can be completed without using a page buffer unit of another memory cell unit. However, when n is greater than m, the remaining page of data can be stored in a page buffer unit of another memory cell unit and a program operation can be performed rapidly.

In other words, m pages of data is stored in a page buffer unit of a first memory cell unit (step 520). The remaining data are stored in a page buffer unit of a second memory cell unit that will not be programmed when the first memory cell unit is programmed (step 530). If the input data remains, then those are stored in a page buffer of a third memory cell unit, and so on.

At step 540, the input data stored in the page buffer unit of the first memory cell unit are programmed. Step 540 occurs in parallel to step 530 in the present embodiment.

For example, in the case of a page buffer having the dual register structure shown in FIG. 2, a first page of data is stored in a first register and then stored in a second register through transmission between the registers. Next, a second page of data is stored in the first register. The first page of data stored in the second register is applied to a sense node and programmed into a memory cell. After the program operation is completed, the second page of data stored in the first register is applied to the sense node and programmed into another memory cell.

In another implementation, the program operation may be performed after all of the input data have been stored in the page buffer units.

After the program operation on the first to m^{th} page of data has been completed, m page of data stored in a page buffer of a second memory cell unit is transferred to the page buffer unit of the first memory cell unit (step 550). The m page of data is programmed into the first memory cell unit (step 560).

The steps 550 and 560 are repeated until the program operation is completed. As described above, as data to be stored in a specific memory cell unit is stored in page buffers of other memory cell units, a program operation can be performed without the use of an input buffer.

In accordance with the above configurations of the present invention, external input data can be temporarily stored in page buffers of memory cell units that do not perform a program operation. Thus, a program operation can be performed even without an additional input buffer. Accordingly, there is the size of a non-volatile memory device can be reduced since an input buffer can be removed from the non-volatile memory device.

The embodiments disclosed herein have been proposed to allow a person skilled in the art to easily implement the present invention, and the person skilled in the part may implement the present invention by a combination of these embodiments. Therefore, the scope of the present invention is not limited by or to the embodiments as described above, and should be construed to be defined only by the appended claims and their equivalents.

What is claimed is:

1. A method of programming a non-volatile memory device, the method comprising:
inputting n pages of data;
storing a page of data in each of page buffer units of a plurality of memory cell units;
programming a first page of data stored in a first page buffer unit of a first memory cell unit into cells associated with the first memory cell unit;
transferring a second page of data stored in a second page buffer unit of a second memory cell unit to the first page buffer unit of the first memory cell unit; and
programming the transferred second page of data into cells associated with the first memory cell unit.

2. The method of claim 1, further comprising:
transferring a k^{th} page of data stored in a k^{th} page buffer unit of a k^{th} memory cell unit to the first page buffer unit of the first memory cell unit;
programming the transferred k^{th} page of data to cells associated with the first memory cell unit; and
repeating the transferring and programming steps until the n pages of data have been programmed entirely.

3. A method of programming a non-volatile memory device, the method comprising:
receiving n pages of data;
storing a first page of data in a first page buffer unit of a first memory cell unit;
programming the first page of data into first cells of the first memory cell unit;
storing a second page of data in a second page buffer unit of a second memory cell unit;
transferring the second page of data to the first page buffer unit of the first memory cell unit after the first page of data has been programmed; and
programming the transferred second page of data to second cells of the first memory cell unit.

4. The method of claim 3, further comprising:
storing a k^{th} page of data in a k^{th} page buffer unit of a k^{th} memory cell unit;
transferring the stored k^{th} page of data to the first page buffer unit of the first memory cell unit;
programming the transferred k^{th} page of data into k^{th} cells of the first memory cell unit; and
repeating the transferring-the-stored-k^{th}-page-of-data and programming-the-transferred-k^{th}-page-of-data steps until the n pages of data have all been programmed.

5. A method of programming a non-volatile memory device, the method comprising:
receiving n pages of data;
storing m pages of data in page buffer units of a plurality of memory cell units, each memory cell unit including one page buffer unit, each page buffer unit being configured to store one or more pages of data;
programming a first set of data stored in a first page buffer unit of a first memory cell unit into first cells of the first memory cell unit, the first set of data including one or more pages of data;
transferring a second set of data stored in a second page buffer unit of a second memory cell unit to the first page buffer unit of the first memory cell unit, the second set of data including one or more pages of data; and
programming the transferred second set of data into second cells of the first memory cell unit.

6. The method of claim 5, wherein the m pages of data are stored sequentially on each memory cell unit including a page buffer having m registers.

7. The method of claim 5, further comprising:
transferring a k^{th} set of data stored in a page buffer unit of a k^{th} memory cell unit to a first page buffer unit of a first memory cell unit, the k^{th} set of data including one more pages of data;
programming the transferred k^{th} set of data into k^{th} cells of the first memory cell unit; and
repeating the transferring-the-stored-k^{th}-set-of-data and programming-the-transferred-k^{th}-set-of-data steps until the n pages of data are all programmed.

8. A method of programming a non-volatile memory device, the method comprising:
receiving n pages of data;
storing a first set of data in a first page buffer unit of a first memory cell unit, the first set of data including one or more pages of data;
programming the first set of data into first cells of the first memory cell unit;
transferring a second set of data stored in a second page buffer unit of a second memory cell unit to the first page buffer unit of the first memory cell unit, the second set of data including one or more pages of data; and
programming the transferred second set of data into second cells of the first memory cell unit.

9. The method of claim 8, wherein the first set of data includes m pages of data, wherein the first page buffer unit has a plurality of page buffers each having m registers.

10. The method of claim 8, further comprising:
storing a k^{th} set of data in a k^{th} page buffer unit of a k^{th} memory cell unit, the k^{th} set of data including one or more pages of data;
transferring the k^{th} set of data to the first page buffer unit of the first memory cell unit;
programming the transferred k^{th} set of data into k^{th} cells of the first memory cell unit; and
repeating the transferring-the-stored-k^{th}-set-of-data and programming-the-transferred-k^{th}-set-of-data steps until the n pages of data are all programmed.

11. A method of programming a non-volatile memory device, the method comprising:
receiving input data comprising a plurality of pages of data;
storing the plurality of pages of data in first and second page buffer units of first and second memory cell units, respectively, the first page buffer unit storing a first set of data including one or more pages of data, the second page buffer unit storing a second set of data including one or more pages of data; and
programming the first set of data into first cells of the first memory cell unit; and
programming the second set of data into second cells of the first memory cell unit.

12. The method of claim 11, wherein the storage of the plurality of pages of data comprises storing a single page of data in a page buffer unit of each memory cell unit.

13. The method of claim 11, wherein the storage of the plurality of pages of data comprises storing m pages of data in each page buffer unit including a page buffer having m registers.

14. The method of claim 11, further comprising:
transferring the second set of data stored in a second page buffer unit of a second memory cell unit to the first page buffer unit of the first memory cell unit, so that the second set of data can be programmed into the second cells of the first memory cell unit.

15. The method of claim 14, wherein programming an n^{th} set of data comprises:
transferring the n^{th} set of data stored in an n^{th} page buffer of an n^{th} memory cell unit to the first page buffer unit of the first memory cell unit;
programming the transferred n^{th} set of data into n^{th} cells of the first memory cell unit.
